(19) United States
(12) Patent Application Publication
(10) Pub. No.: US 2011/0161519 A1
(43) Pub. Date: Jun. 30, 2011

(54) METHOD AND APPARATUS FOR PROVIDING A TRANSIT SERVICE FOR AN AGGREGATE ENDPOINT

(76) Inventors: STEVEN A. SIEGEL, Mendham, NJ (US); Martin C. Dolly, Forked River, NJ (US); Leticia D. Johnson, Helotes, TX (US); Nancy E. Lambros, Spicewood, TX (US); Ricardo E. Sabat, Monroe Township, NJ (US)

(21) Appl. No.: 12/647,347

(22) Filed: Dec. 24, 2009

(51) Int. Cl. G06F 15/16

(52) U.S. Cl. 709/238

(57) ABSTRACT

A method and an apparatus for providing a transit service in a communications network are disclosed. For example, the method receives a session request by a routing device, where the session request is directed towards a user endpoint device that accesses one or more services via the aggregate endpoint device, and interrogates a Home Subscriber Server (HSS) for domain information of the aggregate endpoint device. The method determines if the domain information of the aggregate endpoint device is associated with a transit function, and routes the session request to the transit function for completion, if the domain information of the aggregate endpoint device is associated with the transit function.

The present disclosure relates generally to communication networks and, more particularly, to a method and apparatus for providing a transit service for an aggregate endpoint.

### BACKGROUND

A network service provider may wish to enable customers to subscribe to services that have different network capabilities. In one example, a customer may have a need to subscribe to a service that requires access to various application servers. The call processing for the customer may then require processing by a routing device that maintains states. In another example, a customer may only wish to subscribe to a service that does not offer a full menu of applications. Handling calls to subscribers of a service with minimal features in the same manner as a service that requires maintaining states is costly. This problem is further amplified for sessions that are to be terminated to an aggregate endpoint, e.g., a private branch exchange (PBX) and the like.

### SUMMARY

In one embodiment, the present disclosure discloses a method and an apparatus for providing a transit service in a communications network. For example, the method receives a session request by a routing device, where the session request is directed towards a user endpoint device that accesses one or more services via the aggregate endpoint device, and interrogates a Home Subscriber Server (HSS) for domain information of the aggregate endpoint device. The method determines if the domain information of the aggregate endpoint device is associated with a transit function, and routes the session request to the transit function for completion, if the domain information of the aggregate endpoint device is associated with the transit function.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates an exemplary network in accordance with one embodiment of the current disclosure for providing a transit service over a network;

FIG. 3 illustrates a flowchart of a method for providing a transit service over a network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and apparatus for providing a transit service over a network. Although the present disclosure is discussed below in the context of IP networks, e.g., an Internet Protocol (IP) Multimedia Subsystem (IMS) network, the present disclosure is not so limited. Namely, the present disclosure can be applied to packet networks in general, e.g., Voice over Internet Protocol (VoIP) networks, Service over Internet Protocol (SoIP) networks, and the like.

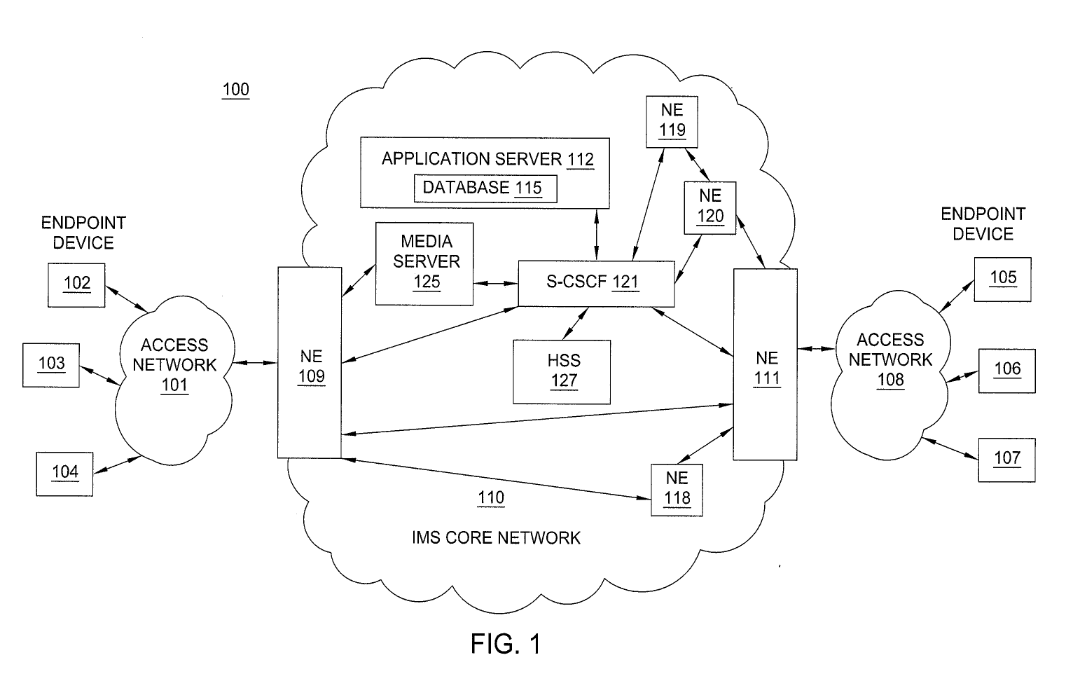

To better understand the teachings of the present method and apparatus, FIG. 1 illustrates an example network 100, e.g., an Internet Protocol (IP) Multimedia Subsystem network related to the present disclosure. An IP network is broadly defined as a network that uses Internet Protocol to exchange data packets. Exemplary IP Multimedia Subsystem (IMS) networks include Internet protocol (IP) networks such as Voice over Internet Protocol (VoIP) networks, Service over Internet Protocol (SoIP) networks, and the like.

In one embodiment, the network 100 may comprise a plurality of endpoint devices 102-104 configured for communication with the core IMS network 110 (e.g., an IP based core backbone network supported by a service provider) via an access network 101. Similarly, a plurality of endpoint devices 105-107 are configured for communication with the IMS core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), mobile phones, smart phones, PBXs, aggregate endpoints (e.g., an aggregate endpoint that employs a SIP user agent to interact with the network on behalf of a plurality of endpoints aggregated behind it) and the like. The access networks 101 and 108 serve as a means to establish a connection between the endpoint devices 102-107 and the Network Elements (NEs) 109 and 111 of the IMS core network 110. The access networks 101 and 108 may each comprise a Digital Subscriber Line (DSL) network, a broadband cable access network, a Local Area Network (LAN), a Wireless Access Network, a 3^{rd} party network, and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy server, a border element, a firewall, a switch, and the like. An NE may also reside within the network (e.g., NEs 118-120) and may be used as a SIP server, an application server, a core router, or like device.

The IMS core network 110 also comprises a Home Subscriber Server (HSS) 127, a Serving—Call Session Control Function (S-CSCF) 121, a Media Server (MS) 125, and an Application Server 112 that contains a database 115. For a specific session, the S-CSCF of the calling party and the S-CSCF of the called party are also referred to as the originating S-CSCF and the terminating S-CSCF, respectively. An HSS 127 refers to a network element residing in the control plane of the IMS network that acts as a central repository of all customer specific authorizations, service profiles, preferences, etc.

The S-CSCF 121 resides within the IMS core infrastructure and is connected to various network elements (e.g., NEs 109 and 111) using the Session Initiation Protocol (SIP) over the underlying IMS based core backbone network 110. The S-CSCF 121 may be implemented to register users and to provide various services (e.g., VoIP services). The S-CSCF interacts with the appropriate VoIP/SoIP service related applications servers (e.g., 112), when necessary. The S-CSCF 121 performs routing and maintains session timers. The S-CSCF may also interrogate an HSS to retrieve authorization, service information, user profiles, etc. In order to complete a call that requires certain service specific features, the S-CSCF may need to interact with various application servers (e.g., various VoIP servers). For example, the S-CSCF may need to interact with another server for translation of an E.164 voice network address into an SIP URI, and so on. For example, the S-CSCF routes to a P-CSCF indicated by the SIP URI. The P-CSCF then routes to the SIP User Agent (UA) over a relationship that is established between the P-CSCF and the SIP UA which may represent an aggregate endpoint. This relationship could be a SIP trunk.

The Media Server (MS) 125 is a special server that typically handles and terminates media streams to provide services such as announcements, bridges, and Interactive Voice Response (IVR) messages for VoIP service applications. The media server also interacts with customers for media session management to accomplish tasks such as process requests.

The application server 112 may comprise any server or computer that is well known in the art, and the database 115 may be any type of electronic collection of data that is also well known in the art. Those skilled in the art will realize that the communication system 100 may be expanded by including additional endpoint devices, access networks, network elements, application servers, etc. without altering the scope of the present disclosure.

The above IP network is described to provide an illustrative environment in which packets for voice, data, and multimedia services are transmitted on IP Multimedia Subsystem (IMS) networks. In one embodiment, the service provider may wish to enable customers to subscribe to services that have different network capabilities. In one example, a customer may have a need to subscribe to a service that requires access to various application servers. The call processing for the customer may then require processing by a routing device that maintains states. In another example, a customer may only wish to subscribe to a service that does not offer a full menu of applications. Handling calls to subscribers of a service with minimal features in the same manner as those that require maintaining states is costly. The cost of handling a call session via a stateful routing device may be unacceptable for such services.

In one embodiment, the current method provides a transit service in a network that incorporates the advantages of the lower cost model of the stateless processing, without adding cost and delay to session requests that require stateful processing. In order to more clearly describe the current method and apparatus, the following networking terminologies are first provided.

E.164; and

ENUM (tElephone NUmbering Mapping).

E.164 refers to an ITU (International Telecommunications Union)-T recommendation which defines the international public telecommunication numbering plan for formatting telephone numbers such that they may be signaled across one or more networks. The E.164 format includes a country code and subsequent digits, but not the international prefix.

ENUM refers to a standard protocol defined by the Internet Engineering Task Force (IETF) for translating phone numbers that are in E.164 format to Internet domain names such that a Domain Name Server (DNS) may resolve the IP addresses for E.164 numbers the same way it resolves traditional website domains. For example, ENUM may be used to transform a phone, a fax or a pager number into a URI (Uniform Resource Identifier).

In order to translate a phone number to an Internet Domain name, the phone number is first provided in an E.164 format. Specifically, the phone number is first translated or converted to a full E.164 formatted number. For example, the original phone number may not have indicated a country code, area code, etc. However, an E.164 formatted phone number includes a country code, area code and the specific number within the area code. For example, “1” is the country code for all phone numbers in the United States of America (USA). If the original USA phone number is 987-555-1234, it is translated to an E.164 formatted number yielding 1-987-555-1234. The E.164 number is then reduced to digits only, e.g., 19875551234. The digits are then reordered back to front, e.g. 43215557891. Once the digits are reordered, dots are placed between each digit and the Internet domain e164.arpa is added to the end. For the above example, the resulting Internet domain is 4.3.2.1.5.5.5.7.8.9.1.e164.arpa.

In operation, an ENUM server may then be queried by the S-CSCF of the calling party to resolve on the domain name 4.3.2.1.5.5.5.7.8.9.1.e164.arpa. For example, an IP Multimedia Subsystem (IMS) network may use an ENUM server to resolve phone number that is in E.164 format, i.e., the contact information of the phone number. The S-CSCF of the calling party may then query a DNS for the regular routing of the contact information resided in the NAPTR (Naming Authority Pointer) resource records, e.g., the SIP URI. In sum, the S-CSCF of the calling party will send the ENUM query and the ENUM server will return the NAPTR resource records if the E.164 number is registered, wherein the S-CSCF then queries the DNS for the destination of the returned records, e.g., the SIP URI of the called party.

It should be noted that the customer may have a set of NAPTR resource records. For example, the customer may have a SIP address, a telephone number, a presence service number, an email address, etc. The query may then retrieve the set of NAPTR resource records for the customer.

A customer may subscribe to a service that may or may not require various rich network features. In one example, a customer may wish to have a call-waiting feature, a three-way calling feature, a call-forwarding feature, and so on. For services that require rich features, each particular feature is made available to the subscriber by adding the particular application server that supports the feature in a signaling path. The subscriber may then invoke a desired feature. The processing of the session request may then require processing by a routing device that maintains states. The routing device that is capable of maintaining states is also referred to as a stateful routing device.

In another example, a customer may only subscribe to a basic service without any rich features. If the customer subscribes to a service that does not offer any of the rich features, handling calls to and from the subscriber may not require maintaining states. Hence, the session request may be handled using a routing device that does not have a capability for maintaining states. Hence, the service provider may first separate out session requests for customers that do not require processing via a stateful routing device.

For example, in one embodiment a service provider may implement a transit function. The transit function refers to a routing proxy that has knowledge of the application server to which a session request is to be routed. In one embodiment, the transit function is used for transit services that require only stateless routing. For a session request that requires only stateless call processing, the transit function may process the session request in accordance with its own knowledge of which application server the session request is to be routed. If the session request is intended for stateful call processing, in one embodiment the transit function may forward the session request to an Interrogating-Call Session Control Function (I-CSCF).

However, the use of IMS networks and their rich features have increased exponentially. Consequently, the number of session requests that are forwarded to a stateful routing device has also increased. Processing of session request by a transit function to determine whether or not it should be forwarded to a stateful routing device, while most of the session requests eventually have to be handled by a stateful routing device, adds processing cost and processing delay for each session request.

In one embodiment, the current method provides a transit service that incorporates the advantages of the lower cost model of the stateless processing, without adding cost and delay for processing of session requests that require stateful routing devices. For example, the current method enables an I-CSCF to receive session requests and to forward the session requests to either a transit function or a terminating S-CSCF.

First, the method enables registering SIP-Uniform Resource Identifier (SIP-URI) of the transit functions. The method then enables customers to subscriber to a service, wherein the service may be provided via a transit function or an S-CSCF. For example, the customer may register a preference in an HSS which serves as a central repository of all customer specific authorizations, service profiles, preferences, etc. For example, a first customer may select a service that has features that need processing via an S-CSCF. In another example, a second customer may select a service that has no features requiring maintenance of states. Hence, session requests associated with the second customer can be processed via the transit function, while session requests associated with the first customer are processed via an S-CSCF. Upon registering, the customer may then be assigned a Public User Identity (PUID) to identify the customer (broadly a user, a user endpoint device or an aggregate endpoint device currently associated with the user), and either a transit function or an S-CSCF for servicing an endpoint device associated with the user. It should be noted that PUID is also known as IM Public user identity (IMPU) under the 3rd Generation Partnership Project (3GPP).

In one embodiment, the current method also enables an HSS, when queried, to retrieve the address, e.g., the SIP URI, of the S-CSCF or transit function. For example, the HSS may return the domain information of the called party. For example, the HSS may return a Serving-Call Session Control Function Fully Qualified Domain Name (S-CSCF FDQN) or a SIP-URI of the transit function serving the called party. Thus, broadly, a method deployed at the HSS receives a query, e.g., a LIR with the PUID from the request-URI, performs a lookup, and then returns a LIA message that contains an S-CSCF FDQN or a SIP URI of a transit function.

In one embodiment, the current method also enables session requests to be sent to an I-CSCF during call processing without first being sent to a transit function. The I-CSCF may then query an HSS for the address, e.g., the SIP URI, of an S-CSCF or transit function. If the HSS returns an S-CSCF FDQN, the session request may then be forwarded to the S-CSCF for termination. If the HSS returns a SIP-URI of a transit function, the session request may then be forwarded to the transit function.

When the above S-CSCF of the calling party queries the ENUM and DNS servers, the query may result in a successful response or failure. If the S-CSCF of the calling party fails to receive a successful response to the query (queries) sent to the ENUM and DNS, the S-CSCF either rejects the call or assumes that the called party is a customer of a Public Switched Telephone Network (PSTN). If the S-CSCF assumes that the called party is a customer of a PSTN, then the S-CSCF of the calling party forwards the call to the PSTN network via a Border Gateway Control Function (BGCF) and/or Media Gateway Control Function (MGCF). If the called party is indeed a customer of the PSTN, then the call may successfully complete over the PSTN.

If the S-CSCF of the calling party receives a successful response to the query (queries) sent to the ENUM and DNS, the S-CSCF of the calling party then routes the call signaling to the Interrogating-Call Session Control Function (I-CSCF) of the returned domain for termination. That is, the S-CSCF of the calling party routes the call signaling to the I-CSCF handling termination at the destination of the returned record. The I-CSCF handling termination at the destination of the returned record may then interrogate the HSS to determine the S-CSCF or the transit function serving the called party. If the HSS then returns a Serving-Call Session Control Function Fully Qualified Domain Name (S-CSCF FDQN) of the called party, the I-CSCF handling the termination of the destination record routes the received (incoming) session request (SIP INVITE message) to the S-CSCF of the called party for completion. If the HSS returns a SIP-URI of the transit function serving the called party, the I-CSCF handling the termination of the destination record routes the received (incoming) session request (e.g., SIP INVITE message) to the transit function of the called party for completion.

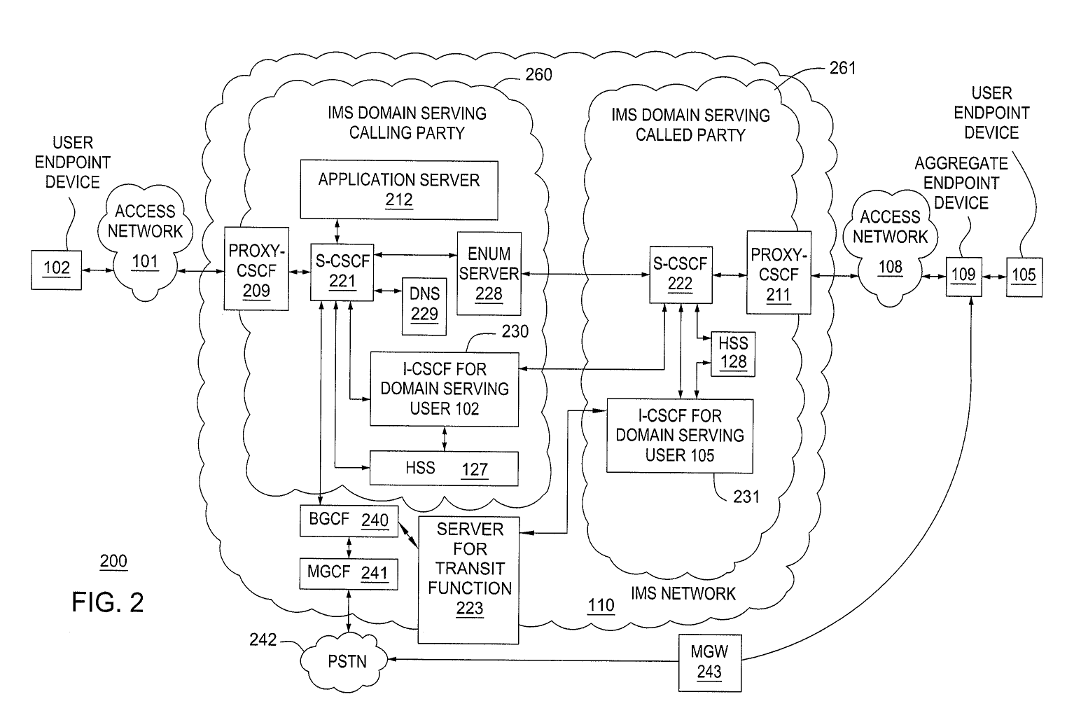

FIG. 2 illustrates an exemplary network 200 in accordance with one embodiment of the current disclosure for providing a transit service over a network. In one embodiment, the network 200 comprises User Endpoint (UE) device 102 communicating with an IMS network 110 via an access network 101, and UE device 105 communicating with the IMS network 110 via an access network 108 and an aggregate endpoint device 109. The aggregate endpoint device 109 comprises a multi-user endpoint device that support a plurality of user endpoint devices.

For illustration, the IMS network 110 comprises domains 260 and 261. In one embodiment, the IMS network 110 also comprises a server for providing transit function 223, a BGCF 240 and a MGCF 241. It should be noted that the IMS network 110 may comprise any number of domains, any of the elements can be moved to another domain, and/or may serve multiple domains. It should also be noted that the IMS domains 260 and 261 may employ similar network components and may have various other components. The present disclosure includes only the components that are needed to describe the current method and apparatus with simplicity.

In one embodiment, the IMS domain 260 comprises a P-CSCF 209, a HSS 127, a S-CSCF 221, an I-CSCF 230, an ENUM server 228, a DNS 229, and an application server 212, interconnected for providing services to a plurality of customers. The IMS domain 261 comprises a P-CSCF 211, a HSS 128, a S-CSCF 222, and an I-CSCF 231, interconnected for providing services to the plurality of customers. For example, the domain 260 and domain 261 may support various services (e.g., VoIP service, streaming video services, cellular services, etc.). In another embodiment, Aggregate Endpoint 109 may also be connected to IMS Domain 261 through a second Access Network with different Proxy CSCFs.

The customer with UE 102 is served by the domain 260 and the customer with UE 105 is served by the domain 261. Specifically, P-CSCF 209, S-CSCF 221, DNS 229 and I-CSCF 230 are used for serving UE 102, and P-CSCF 211, S-CSCF 222 and I-CSCF 231 are used for serving UE 105.

In one embodiment, the current method provides a transit service to an endpoint device 105 via the transit function 223. In one embodiment, the transit function 223 communicates with the endpoint device 105 via the BGCF 240, MGCF 241, Public Switched Telephone Network (PSTN) 242, Media Gateway (MGW) 243 and aggregate endpoint device 109. For example, the PSTN 242 communicates with the UE 105 via a Media Gateway (MGW) 243. The MGW 243 is used for converting the data from a format required in the PSTN to a format required in the IP network, and vice versa. For example, data sent from the PSTN 242 to the UE 105 is converted by the MGW 243 to a format required by the IP network. Similarly, data sent from the UE 105 to the PSTN 242 is converted by the MGW 243 to a format required by the PSTN 242.

In one example, UE 102 initiates a session towards UE 105 (e.g., sending a SIP INVITE message). The S-CSCF 221 receives the session request via P-CSCF 209. The S-CSCF 221 may then send a query for NAPTR resource records to the ENUM server 228. The ENUM server 228 may then return the NAPTR resource records if the E.164 number is registered. The S-CSCF 221 may then query the DNS 229 for the destination of the returned NAPTR records, e.g., the SIP URI of the called party.

Upon receiving a successful response to the query (queries) sent to the ENUM 228 and DNS 229, the S-CSCF 221 routes the call to the I-CSCF 231 via a border element (not shown). The I-CSCF 231 may then receive and process the session request. Specifically, the I-CSCF 231 receives the session request and interrogates the HSS 128 to determine the address of the S-CSCF or transit function of the called party. The I-CSCF 231 may then receive the S-CSCF FDQN or SIP URI of a transit function. For the example above, I-CSCF 231 receives from the HSS 128 the SIP URI of the transit function 223, which is the server that provides the transit function for the aggregate endpoint device 106 and UE 105. The I-CSCF 231 may then route the session request to the transit function 223 for completion. The transit function 223 then performs the routing towards the aggregate endpoint device 109. The aggregate endpoint device 109 then forwards the session request to UE 105.

Note that the above transit function may be used for aggregate and user endpoint devices that are not serviced via a PSTN. Hence, the current illustrative example is not intended to limit the use of transit function to such services. For example, the transit function may be used to route traffic directly to an aggregate or user endpoint device bypassing routers that maintain states. In one example, a stateless proxy server may be implemented for directly routing the packets towards the aggregate or user endpoint device, without utilizing a terminating S-CSCF.

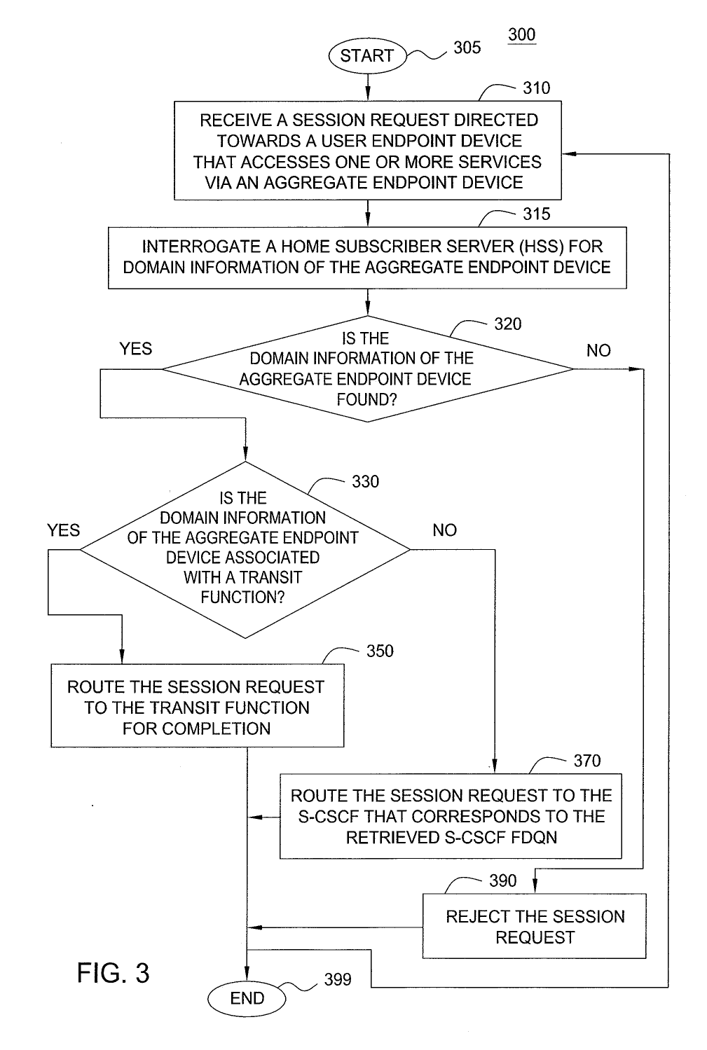

FIG. 3 illustrates a flowchart of a method 300 for a routing device providing a transit service in a network. In one embodiment, the routing device for providing a transit service is an I-CSCF. Method 300 starts in step 305 and proceeds to step 310.

In step 310, method 300 receives a session request directed towards a user endpoint device that accesses one or more services via an aggregate endpoint device. For example, an I-CSCF may receive a SIP INVITE message directed to a subscriber that may or may not have subscribed to a transit service.

In step 315, method 300 interrogates a Home Subscriber Server (HSS) for domain information of the aggregate endpoint device. For example, the I-CSCF may interrogate the HSS to determine the address of the S-CSCF or transit function of the called party. More specifically, the I-CSCF sends a LIR with the PUID from the request-URI to the HSS.

In step 320, method 300 determines if the domain information of the aggregate endpoint device is found. For example, the method may successfully receive either an S-CSCF FDQN or a SIP URI of a transit function from the HSS, e.g., in a LIA message. In another example, the aggregate endpoint device may not be in a domain of the I-CSCF. For example, the user may not be a subscriber of service. If the domain information of the aggregate endpoint device is found, the method proceeds to step 330. Otherwise, the method proceeds to step 390.

In step 330, method 300 determines if the domain information of the aggregate endpoint device is associated with a transit function. For example, the method may determine if a received SIP URI is that of a server for providing transit function. If the domain information of the aggregate endpoint device is associated with a transit function, the method proceeds to step 350. Otherwise, the method proceeds to step 370. It should be noted that step 330 does not require that the I-CSCF makes an affirmative decision. In other words, the returned address from the HSS can simply be inserted by the I-CSCF into the route header such that the session request is forwarded to the identified address of the S-CSCF or the transit function. Thus, in one embodiment step 330 can be broadly interpreted as an address insertion step performed by the I-CSCF.

In step 350, method 300 routes the session request to the transit function for completion. For example, the I-CSCF may route the session request to the transit function for completion. The transit function may then perform the routing towards the aggregate endpoint device, which may route the session request to the UE device. The method may then either proceed to step 399 to end processing the current session request, or proceed to 310 to continue receiving session requests.

In step 370, method 300 routes the session request to the S-CSCF that corresponds to the retrieved S-CSCF FDQN. For example, the I-CSCF may route the session request to the S-CSCF whose address was retrieved from the HSS. The S-CSCF may then perform the routing towards the aggregate endpoint device. The method may then either proceed to step 399 to end processing the current session request, or proceed to 310 to continue receiving session requests.

It is important to note that the above S-CSCF processing the terminating session request may query various application servers prior to forwarding the session request towards its destination. The application servers used in regular call handling procedures are omitted from the above description for clarity.

In step 390, method 300 rejects the session request. The method may then either proceed to step 399 to end processing the current session request, or proceed to 310 to continue receiving session requests.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

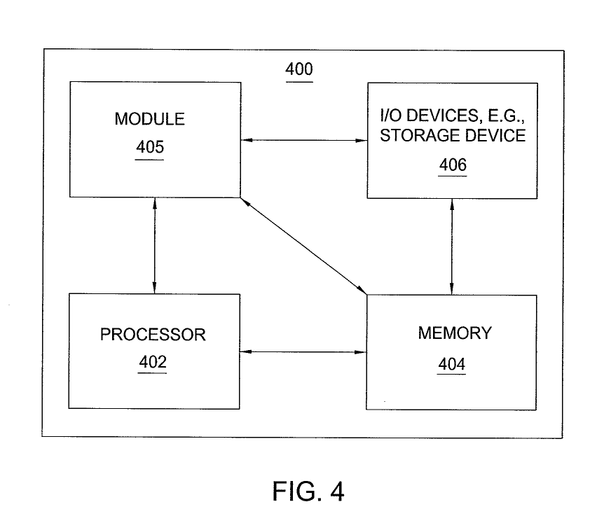

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing a transit service in a network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents. In one embodiment, the present module or process 405 for providing a transit service in a network can be loaded into memory 404 and executed by processor 402 to implement the functions as discussed above. As such, the present method 405 for providing a transit service in a network (including associated data structures) of the present disclosure can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a transit service to an aggregate endpoint device in a network, comprising:
receiving a session request by a routing device, where the session request is directed towards a user endpoint device that accesses one or more services via the aggregate endpoint device;
interrogating a Home Subscriber Server (HSS) for a Public User Identity (PUID) associated with the aggregate endpoint device;
determining if the PUID associated with the aggregate endpoint device is associated with a transit function; and
routing the session request to the transit function for completion, if the PUID associated with the aggregate endpoint device is associated with the transit function.

2. The method of claim 1, wherein the routing device is an Interrogating-Call Session Control Function (I-CSCF).

3. The method of claim 1, further comprising:
determining if the PUID associated with the aggregate endpoint device is associated with a Serving-Call Session Control Function (S-CSCF); and
routing the session request to the S-CSCF for completion, if the PUID associated with the aggregate endpoint device is associated with the S-CSCF.

4. The method of claim 1, wherein the session request comprises an invite message to a called party from a calling party in accordance with a Session Initiation Protocol (SIP).

5. The method of claim 1, wherein the PUID associated with the aggregate endpoint device is associated with a Serving-Call Session Control Function Fully Qualified Domain Name (S-CSCF FDQN), or a Session Initiation Protocol-Uniform Resource Identifier (SIP-URI) of a transit function.

6. The method of claim 1, wherein the HSS determines if the aggregate endpoint device is to be associated with a transit function or an S-CSCF in accordance with a selection of a service by a customer.

7. The method of claim 1, wherein the transit function processes the session request without maintaining states.

8. A computer-readable storage medium having stored thereon a plurality of instructions, the plurality of instructions including instructions which, when executed by a processor, cause the processor to perform steps of a method for providing a transit service to an aggregate endpoint device in a network, comprising:
receiving a session request by a routing device, where the session request is directed towards a user endpoint device that accesses one or more services via the aggregate endpoint device;
interrogating a Home Subscriber Server (HSS) for a Public User Identity (PUID) associated with the aggregate endpoint device;
determining if the PUID associated with the aggregate endpoint device is associated with a transit function; and
routing the session request to the transit function for completion, if the PUID associated with the aggregate endpoint device is associated with the transit function.

9. The computer-readable storage medium of claim 8, wherein the routing device is an Interrogating-Call Session Control Function (I-CSCF).

10. The computer-readable storage medium of claim 8, further comprising:
determining if the PUID associated with the aggregate endpoint device is associated with a Serving-Call Session Control Function (S-CSCF); and
routing the session request to the S-CSCF for completion, if the PUID associated with the aggregate endpoint device is associated with the S-CSCF.

11. The computer-readable storage medium of claim 8, wherein the session request comprises an invite message to a called party from a calling party in accordance with a Session Initiation Protocol (SIP).

12. The computer-readable storage medium of claim 8, wherein the PUID associated with the aggregate endpoint device is associated with a Serving-Call Session Control Function Fully Qualified Domain Name (S-CSCF FDQN), or a Session Initiation Protocol-Uniform Resource Identifier (SIP-URI) of a transit function.

13. The computer-readable storage medium of claim 8, wherein the HSS determines if the aggregate endpoint device is to be associated with a transit function or an S-CSCF in accordance with a selection of a service by a customer.

14. The computer-readable storage medium of claim 8, wherein the transit function processes the session request without maintaining states.

15. An apparatus for providing a transit service to an aggregate endpoint device in a network, comprising:
means for receiving a session request by a routing device, where the session request is directed towards a user endpoint device that accesses one or more services via the aggregate endpoint device;
means for interrogating a Home Subscriber Server (HSS) for a Public User Identity (PUID) associated with the aggregate endpoint device;
means for determining if the PUID associated with the aggregate endpoint device is associated with a transit function; and
means for routing the session request to the transit function for completion, if the PUID associated with the aggregate endpoint device is associated with the transit function.

16. The apparatus of claim 15, wherein the routing device is an Interrogating-Call Session Control Function (I-CSCF).

17. The apparatus of claim 15, further comprising:
means for determining if the PUID associated with the aggregate endpoint device is associated with a Serving-Call Session Control Function (S-CSCF); and
means for routing the session request to the S-CSCF for completion, if the PUID associated with the aggregate endpoint device is associated with the S-CSCF.

18. The apparatus of claim 15, wherein the session request comprises an invite message to a called party from a calling party in accordance with a Session Initiation Protocol (SIP).

19. The apparatus of claim 15, wherein the PUID associated with the aggregate endpoint device is associated with a Serving-Call Session Control Function Fully Qualified Domain Name (S-CSCF FDQN), or a Session Initiation Protocol-Uniform Resource Identifier (SIP-URI) of a transit function.

20. The apparatus of claim 15, wherein the HSS determines if the aggregate endpoint device is to be associated with a transit function or an S-CSCF in accordance with a selection of a service by a customer.
